(19) United States
(12) Patent Application Publication
(10) Pub. No.: US 2010/0038031 A1
(43) Pub. Date: Feb. 18, 2010

(54) Pick-up apparatus for semiconductor chips and pick-up method for semiconductor chips using the same

(75) Inventor: Daisuke Koike, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/585,004

(22) Filed: Aug. 31, 2009

(30) Foreign Application Priority Data
May 9, 2008 (JP) 228930/2008

(51) Int. Cl. B32B 38/00

(52) U.S. Cl. 156/344; 156/584

(57) ABSTRACT

Even in the case of a thin semiconductor chip, the semiconductor chip is delaminated from an adhesive sheet so as to prevent cracking. A pick-up apparatus 1 has a stage 100 on which a dicing sheet 13 is placed, a slider which comes into contact with a back surface of the dicing sheet 13 and moves horizontally, in plan view, with respect to a semiconductor chip 12, a slider housing portion which is formed in the stage 100 and houses the slider, and a suction mechanism 500 which is coupled to the stage 100 and suctions the slider housing portion. On the stage 100, the dicing sheet 13 is placed in a position where the semiconductor chip 12 is opposed to the slider housing portion. The slider is provided with a plurality of slits on a side where the slider comes into contact with the dicing sheet 13. The slit is in communication with the slider housing portion 102.

### BACKGROUND OF THE INVENTION

1. Field of the Invention

The present invention relates to a pick-up apparatus for semiconductor chips which delaminates a semiconductor chip mounted on a surface of an adhesive sheet from the adhesive sheet and a pick-up method for semiconductor chips using this pick-up apparatus.

2. Description of the Related Art

Conventional pick-up apparatus used in the manufacturing process of semiconductor devices are described in Japanese Patent Laid-Open No. 2003-224088 and Japanese Patent Laid-Open No. 2005-328054, for example.

The pick-up apparatus for semiconductor chips described in Japanese Patent Laid-Open No. 2003-224088 is such that a dicing sheet to which a semiconductor chip (hereinafter also called a chip) is stuck is placed on a stage, a roller having a plurality of protruding members is rotated, and these protruding members are pushed up from under the dicing sheet during the rotation of the roller.

The pick-up apparatus for semiconductor chips described in Japanese Patent Laid-Open No. 2005-328054 is such that a dicing sheet to which a chip is stuck is placed on a stage and is caused to slide by pushing up a plurality of protruding members from the stage from under the dicing sheet.

In recent years, with semiconductor devices (semiconductor packages) becoming thinner, thinner designs of semiconductor chips constituting these semiconductor devices have been required.

However, in the related arts described in Japanese Patent Laid-Open No. 2003-224088 and Japanese Patent Laid-Open No. 2005-328054, when attempting to pick up a thin semiconductor chip, the semiconductor chip cannot withstand the force which peels the chip from the adhesive sheet and the semiconductor chip will become cracked or chipped. The larger the semiconductor chip, the greater this problem will be. Therefore, the yield of large thin semiconductor chips may decrease.

### SUMMARY

According to the present invention, there is provided a pick-up apparatus for semiconductor chips which delaminates a semiconductor chip mounted on one surface of an adhesive sheet from the adhesive sheet, which includes: a stage on which the adhesive sheet is placed; at least one or more sliders which come into contact with the other surface of the adhesive sheet and move horizontally, in plan view, with respect to the semiconductor chip; a slider housing portion which is formed in the stage and houses the slider; and a suction mechanism which is coupled to the stage and suctions the slider housing portion. On the stage, the adhesive sheet is placed in a position where the semiconductor chip is opposed to the slider housing portion. The slider is provided with at least one or more slits on a side where the slider comes into contact with the adhesive sheet. The slit is in communication with the slider housing portion.

Also according to the present invention, there is provided a pick-up method for semiconductor chips which delaminates a semiconductor chip mounted on one surface of an adhesive sheet from the adhesive sheet by using a pick-up apparatus. The pick-up apparatus includes: a stage on which the adhesive sheet is placed; at least one or more sliders which come into contact with the back surface of the adhesive sheet and move horizontally, in plan view, with respect to the semiconductor chip; a slider housing portion which is formed in the stage and houses the slider; a suction mechanism which is coupled to the stage and suctions the slider housing portion; and at least one or more slits which are provided on a side where the slider comes into contact with the adhesive sheet, and are in communication with the slider housing portion. The pick-up method includes the steps of: placing the adhesive sheet on the stage from a back surface in a position where the slider housing portion is opposed to the semiconductor chip and bringing the adhesive sheet into contact with the slider; suctioning the slider housing portion; and moving the slider horizontally, in plan view, with respect to the semiconductor chip.

According to the present invention, the slit provided on a side where the slider comes into contact with the adhesive sheet is in communication with the slider housing portion. As a result of this, the suction mechanism suctions the slit by suctioning the slider housing portion and can generate a negative pressure in a space formed by the slit and the adhesive sheet. Thanks to this negative pressure it is possible to suction the adhesive sheet and it is possible to peel off part of the adhesive sheet from the semiconductor chip. Because a negative pressure is generated also in a space formed by a peripheral edge part of the slider housing portion and the adhesive sheet, it is also possible to suction the adhesive sheet opposed to the peripheral edge part of the slider housing portion to peel it from the semiconductor chip. Therefore, a plurality of initiation points of delamination which are distributed from each other are formed and when the slider is moved horizontally with respect to the semiconductor chip, it is possible to increase the size of delaminated areas gradually from the above-described initiation points. Hence, it is possible to distribute the force acting on the semiconductor chip during the delamination of the adhesive sheet from the semiconductor chip and as a result of this, it is possible to prevent cracking even in the case of a large thin chip.

Incidentally, various kinds of component elements of the present invention need not to be individually independent. It is necessary only that a plurality of component elements be formed as one member, that one component element be formed of a plurality of members, that a component element be part of another component element, and that part of a component element overlaps part of another component element, and the like.

Although a plurality of steps are described in order in the pick-up method for semiconductor chips of the present invention, the order of the description does not limit the order of carrying out a plurality of steps. For this reason, in carrying out the pick-up method for semiconductor chips of the present invention, it is possible to change the order of the plurality of steps so long as this does not affect the nature of the steps.

According to the present invention, it is possible to peel off even a thin semiconductor chip from an adhesive sheet while preventing cracking. Therefore, it is possible to increase the fabrication efficiency in the pick-up step of semiconductor chips.

### BRIEF DESCRIPTION OF THE DRAWINGS

FIG. 1 is a schematic side view showing a pick-up apparatus in the first embodiment of the present invention;

FIGS. 2A and 2B are plan views of the pick-up apparatus in the first embodiment of the present invention;

FIGS. 3A to 3C are sectional views of the pick-up apparatus in the first embodiment of the present invention to explain the operation of the apparatus;

FIGS. 4A to 4C are plan views of a pick-up apparatus in the second embodiment of the present invention to explain the operation of the apparatus; and

FIGS. 5A and 5B are plan view of the pick-up apparatus in the second embodiment of the present invention.

### DETAILED DESCRIPTION OF THE PREFERRED EMBODIMENTS

Embodiments of the present invention will be described below with reference to the drawings. Incidentally, in all of the drawings, like reference numerals refer to like component elements and descriptions of such component elements are appropriately omitted.

### First Embodiment

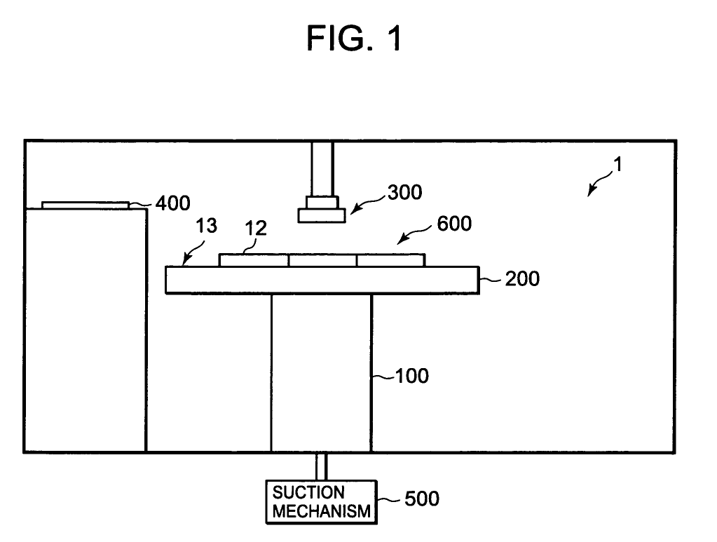

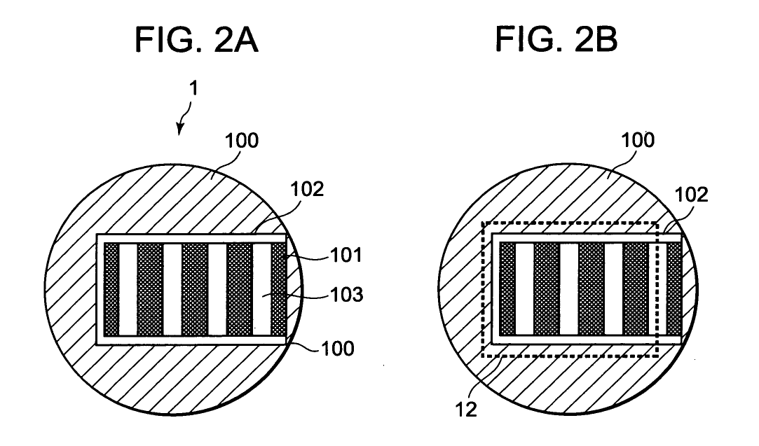

FIG. 1 and FIGS. 2A and 2B are schematic diagrams showing a pick-up apparatus 1 of the first embodiment. FIG. 1 is a side view of the pick-up apparatus 1 of the first embodiment. FIGS. 2A and 2B are plan views of the pick-up apparatus 1 of the first embodiment.

As shown in FIG. 1, the pick-up apparatus 1 is a pick-up apparatus for semiconductor chips which delaminates a semiconductor chip 12 mounted on one surface (a front surface) of a dicing sheet (an adhesive sheet) 13 from the dicing sheet 13. The pick-up apparatus 1 has a stage 100 on which a dicing sheet 13 is placed, a slider 101 which comes into contact with the other surface (a back surface) of the dicing sheet 13 and moves horizontally, in plan view, with respect to a semiconductor chip 12, a slider housing portion 102 which is formed in the stage 100 and houses the slider 101, and a suction mechanism 500 which is coupled to the stage 100 and suctions the slider housing portion 102. On the stage 100, the dicing sheet 13 is placed in a position where the semiconductor chip 12 is opposed to the slider housing portion 102. The slider 101 is provided with a plurality of slits 103 on a side where the slider 101 comes into contact with the dicing sheet 13. The slit 103 is in communication with the slider housing portion 102.

As shown in FIG. 2, the slit 103 extends in a direction orthogonal to the moving direction of the slider 101, preferably, at right angles, in plan view, to the side of the slider 101. A gap is formed between the stage 100 and the slider 101, and this gap constitutes part of the slider housing portion 102. Therefore, this gap is suctioned by the suction mechanism 500, whereby a negative pressure is formed between the stage 100 and the slider 101, and the slit 103 comes into a negative pressure condition.

The pick-up apparatus 1 can be suitably used in picking up semiconductor chips 12 having sizes of 1 to 20 mm and substrate thicknesses of 5 to 200 μm. The semiconductor chip 12 picked up by the pick-up apparatus 1 can be used in the fabrication of devices, such as mobile-system LSIs.

An expander 200 is a unit which fixes a wafer ring (not shown). After dicing, a semiconductor wafer 600 is mounted on the expander 200 and is expanded.

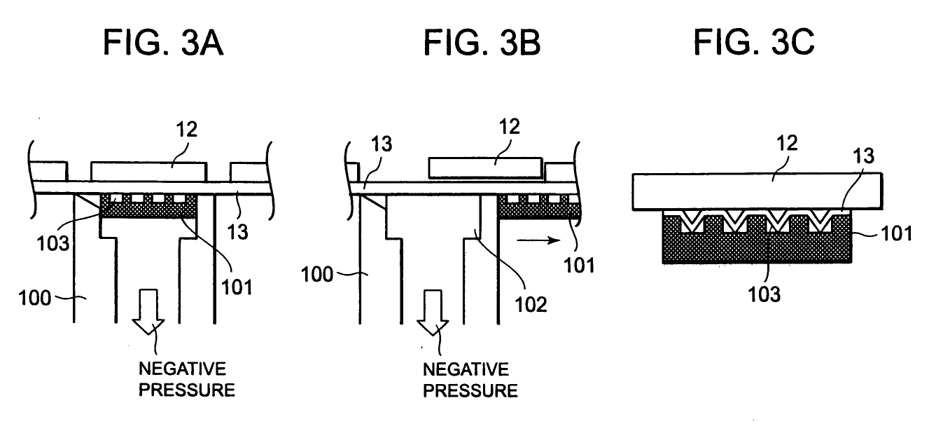

FIGS. 3A to 3C are diagrams to explain how the pick-up apparatus 1 delaminates the semiconductor chip 12 from the dicing sheet 13. FIGS. 3A to 3C are sectional views of the pick-up apparatus 1. How the semiconductor chip 12 is delaminated from the dicing sheet 13 will be described with reference to FIGS. 3A to 3C.

First, the slider 101 is housed in the slider housing portion 102, and the dicing sheet 13 is placed from a back surface on the stage 100 in a position where the slider housing portion 102 is opposed to the semiconductor chip 12 (FIG. 3A). As a result of this, the dicing sheet 13 comes into contact with the slider 101 and a closed space is formed between the slider housing portion 102 and the dicing sheet 13. An upper surface of the slit 103 is covered with the dicing sheet 13, whereby a space in communication with the slider housing portion 102 is formed between the slit 103 and the dicing sheet 13. A semiconductor wafer 600 is diced and expanded. The diced semiconductor wafer 600 is formed of a plurality of semiconductor chips 12.

Subsequently, the slider housing portion 102 is suctioned by the suction mechanism 500 (FIG. 3A). As a result of this, a negative pressure is generated in the closed space formed between the slider housing portion 102 and the dicing sheet 13. At this moment, the slit 103 reaches a side surface of the slider 101 and a connection between the side surface of the slider 101 and the slit 103 is open. Therefore it follows that a negative pressure is generated also in the space formed between the slit 103 and the dicing sheet 13. It is possible to suction the dicing sheet 13 in contact with the slider 101 via the slit 103. Therefore it follows that, as shown in the enlarged view of FIG. 3C, part of the dicing sheet 13 peels off from the semiconductor chip 12 and comes into contact with the slit 103.

Between the slider 101 and the slider housing portion 102, a gap of a prescribed width is formed. For this reason, it follows that also this gap is suctioned by the suction mechanism 500. Therefore, the dicing sheet 13 held opposed to the peripheral edge part of the slider housing portion 102 is suctioned and peels off from the semiconductor chip 12. Furthermore, when the dicing sheet 13 is arranged on the stage 100 so that the peripheral edge part of the slider housing portion 102 and the peripheral edge part of the semiconductor chip 12 are opposed to each other, it is possible to peel off the dicing sheet 13 sticking to the peripheral edge part of the semiconductor chip 12. At this time, by appropriately controlling the suction force, it is possible to peel off the dicing sheet 13 with an appropriate suction force and hence it is possible to prevent the chipping of the semiconductor chip 12.

As shown in FIG. 2B, the slit 103 is formed in a position corresponding to the middle part of the semiconductor chip 12, whereby it is possible to peel off the dicing sheet 13 from the middle part of the semiconductor chip 12. As a result of this, it is possible to peel off also the middle part of the semiconductor chip 12 which is difficult to peel off at the same time with the peeling off of the peripheral edge part of the chip.

Again in FIG. 3B, the slider 101 is caused to move horizontally with respect to the semiconductor chip 12. At this moment, as described above, because the part of the dicing sheet 13 opposed to the slit 103 is delaminated from the semiconductor chip 12, it follows that an initiation point of delamination is formed. Hence, it is possible to gradually increase the size of delaminated areas horizontally from the above-described initiation point of delamination as the slider 101 moves. Also, because the part of the dicing sheet 13 opposed to the peripheral edge part of the slider housing portion 102 is delaminated from the semiconductor chip 12, it follows that an initiation point of delamination is formed also in this part. Hence, as described above, it is possible to gradually increase the size of delaminated areas horizontally from the above-described initiation point of delamination as the slider 101 moves. The size of delaminated areas of the dicing sheet 13 is gradually increased in this manner from the plurality of initiation points which are distributed from each other, and it follows from this that the whole semiconductor chip 12 becomes delaminated from the dicing sheet 13.

The delaminated semiconductor chip 12 is picked up by being adsorbed onto a bonding head 300 shown in FIG. 1. The bonding head 300 mounts the picked-up semiconductor chip 12 onto a die mounter 400. By placing a substrate beforehand on the die mounter 400, it is also possible to mount the semiconductor chip 12 on the substrate.

Subsequently, the operational advantage of this embodiment will be described with reference to FIG. 1 and FIGS. 2A and 2B. According to the pick-up apparatus 1, the slit 103 provided on a side where the slider 101 comes into contact with the dicing sheet 13 is in communication with the slider housing portion 102. As a result of this, the suction mechanism 500 suctions the slit 103 by suctioning the slider housing portion 102, and can generate a negative pressure in the space formed by the slit 103 and the dicing sheet 13. Thanks to this negative pressure, it is possible to suction the dicing sheet 13 and to peel off part of the dicing sheet 13 from the semiconductor chip 12. Because a negative pressure is generated also in the space formed by the peripheral edge part of the slider housing portion 102 and the dicing sheet 13, it is also possible to peel off the dicing sheet 13 opposed to the peripheral edge part of the slider housing portion 102 from the semiconductor chip 12 by suctioning the dicing sheet 13. Therefore, a plurality of initiation points of delamination which are distributed from each other are formed and when the slider 101 is moved horizontally with respect to the semiconductor chip 12, it is possible to gradually increase the size of delaminated areas from the above-described initiation points. Hence, it is possible to distribute the force acting on the semiconductor chip 12 during the delamination of the dicing sheet 13 from the semiconductor chip 12 and as a result of this, it is possible to prevent cracking even in the case of a large thin chip.

As shown in FIG. 2B, the dicing sheet 13 is caused to be held by the stage 100 so that the slit 103 and the middle part of the semiconductor chip 12 become opposed to each other. For this reason, it is possible to suction the dicing sheet 13 opposed to the slit 103 into slit 103 and it is possible to apply a horizontal tensile force to the dicing sheet 13 which sticks the middle part of the semiconductor chip 12. Hence, it is possible to promote delamination by applying a-horizontal tensile force to the dicing sheet 13 which sticks the middle part of the chip which is difficult to delaminate.

### Second Embodiment

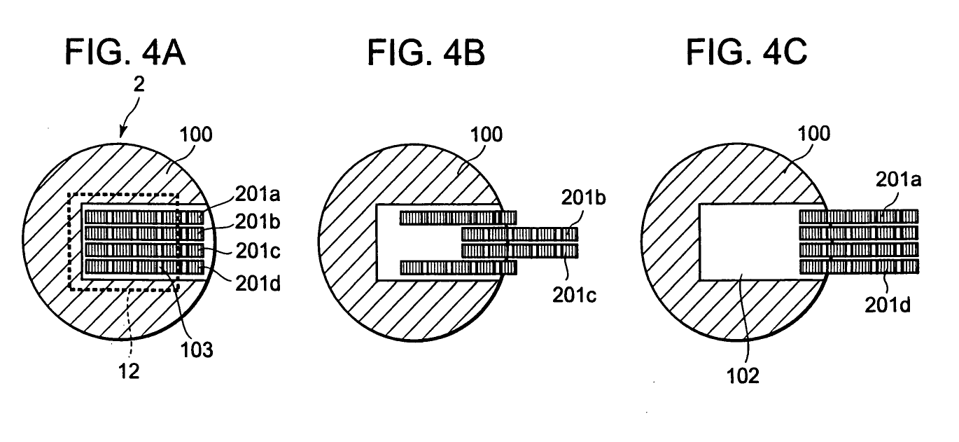

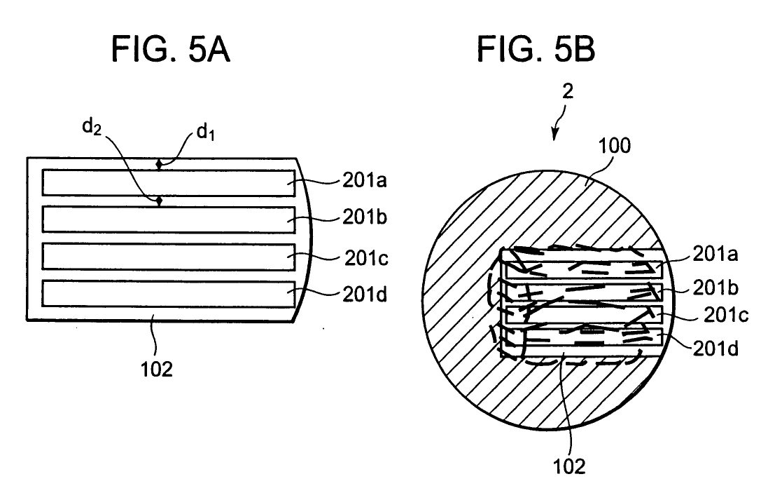

FIGS. 4A to 4C and FIGS. 5A and 5B are plan views showing a pick-up apparatus 2 of the second embodiment. FIGS. 4A to 4C and FIG. 5B are plan views of a stage 100 of the pick-up apparatus 2. FIG. 5A is an enlarged view of part of a slider housing portion 102. In FIGS. 5A and 5B, a slit 103 is omitted. The pick-up apparatus 2 differs from the pick-up apparatus 1 in that, for each semiconductor chip 12, a plurality of sliders 201a, 201b, 201c, 201d are formed be parallel in a manner spaced from each other and in that each of the sliders is movable individually horizontally, in plan view, with respect to a semiconductor chip 12. The sectional view of the pick-up apparatus 2 is the same as in FIGS. 3A to 3C.

Although it is possible to set, as the spacing between the sliders, an optimum distance to match the size and thickness of a chip, the magnitude of a negative pressure generated from a suction mechanism 500, and the adhesive force of a dicing sheet 13, it is possible to set this spacing to be of the same order as the distance of a gap formed between a peripheral edge part of the slider housing portion 102 and each slider. When design is performed so that this spacing becomes d1=d2 as shown in FIG. 5A, it is possible to apply a tensile force evenly. It is also possible to perform design so that each slider spacing differs from the others. In FIG. 5B, the initiation points of delamination are indicated by dotted lines.

The pick-up apparatus 2 is provided with a control section (not shown) which horizontally moves the sliders 201a, 201b, 201c, 201d individually. The control section can move each of the sliders 201a, 201b, 201c, 201d in any order and can also move these sliders simultaneously.

FIGS. 4A to 4C are diagrams to explain how the pick-up apparatus 2 delaminates the semiconductor chip 12 from a dicing sheet 13. FIGS. 4A to 4C are plan views of the pick-up apparatus 2. The sectional view of the pick-up apparatus 2 is the same as in FIGS. 3A to 3C. How the semiconductor chip 12 is delaminated from the dicing sheet 13 will be described with reference to FIGS. 3A to 3C and FIGS. 4A to 4C.

FIG. 4A shows the pick-up apparatus 2 before each slider is brought into action. The sliders 201a, 201b, 201c, 201d are housed in the interior of the stage 100.

First, in the same manner as in the first embodiment, a semiconductor wafer 600 bonded to a front surface of the dicing sheet 13 is prepared on the stage 100 which holds the dicing sheet 13 from a back surface, and the suction mechanism 500 suctions the slider housing portion 102. As a result of this, the dicing sheet 13 in a position opposed to the slit 103 of each slider, the gap of the sliders, and a peripheral edge part of the slider housing portion 102 is suctioned and is peeled off from the semiconductor chip 12.

And each slider is moved horizontally, in plan view, with respect to the semiconductor chip 12 (FIG. 4B). In the example shown in FIG. 4B, only the sliders 201b, 201c are horizontally moved and the sliders 201a, 201d are kept housed in the slider housing portion 102.

After that, the sliders 201a, 201d are horizontally moved later than the sliders 201b, 201c (FIG. 4C).

Incidentally, the sliders 201a, 201b, 201c, and 201d may also be simultaneously moved horizontally.

Subsequently, the operational advantage of this embodiment will be described. In the pick-up apparatus 2, the sliders 201a, 201b, 201c, 201d are formed to be parallel in a manner spaced from each other. For this reason, when the suction mechanism 500 suctions the slider housing portion 102, the dicing sheet 13 in contact with the gap of each slider is suctioned and becomes peeled off from the semiconductor chip 12. Therefore, it is possible to form initiation points of delamination not only in the peripheral edge part of the slider housing portion 102, but also on the circumference of each slider. Also, by individually moving each slider, it is possible to gradually increase the force which pulls the dicing sheet 13 from a back surface. As a result of this, it is possible to effectively delaminate areas of poor delaminability by controlling the movement of each slider. Hence, it becomes possible to delaminate the semiconductor chip 12 from the dicing sheet 13 with good efficiency while preventing the cracking and chipping of the semiconductor chip 12.

If the dicing sheet 13 is drawn into a hollow space formed by the horizontal movement of each slider, the semiconductor chip 12 may be strained and cracked. Therefore, in the pick-up apparatus 2, it is possible to adopt a method which involves, for example, moving first the sliders 201a, 201d on the peripheral edge part sides of the semiconductor chip 12 and thereafter moving the sliders 201b, 201c other than the sliders on the peripheral edge part sides. The hollow spaces formed by the movement of the sliders 201a, 201d are smaller than the hollow spaces formed by the movement of the sliders 201b, 201c. Therefore, it is possible to suppress the strain and crack of the semiconductor chip 12.

As shown in FIGS. 4A to 4C, in the pick-up apparatus 2, each slider is provided with the slit 103. It is preferred that the slit 103 be formed in a position corresponding to the middle part of the semiconductor chip 12. As a result of this, also the middle part of the semiconductor chip 12 incapable of being delaminated between the dicing sheet 13 and the chip can be delaminated at the same time with the delamination of the peripheral part of the chip and it is possible to stably pick-up the semiconductor chip without reducing the yield. By adjusting the action of individual sliders, it is possible to delaminate areas which are difficult to delaminate with better efficiency.

Although the embodiments of the present invention were described above with reference to the drawings, these are merely illustrative of the present invention and it is possible to adopt also various configurations other than the above-described ones.

What is claimed is:

1. A pick-up apparatus for a semiconductor chip which delaminates a semiconductor chip mounted on one surface of an adhesive sheet from the adhesive sheet, comprising:
a stage on which the adhesive sheet is placed;
a slider which comes into contact with the other surface of the adhesive sheet and moves horizontally, in plan view, with respect to the semiconductor chip;
a slider housing portion which is formed in the stage and houses the slider; and
a suction mechanism which is coupled to the stage and suctions the slider housing portion,
wherein on the stage, the adhesive sheet is placed in a position where the semiconductor chip is opposed to the slider housing portion,
the slider is provided with a slit on a side where the slider comes into contact with the adhesive sheet, and
the slit is in communication with the slider housing portion.

2. The pick-up apparatus for a semiconductor chip according to claim 1, wherein the slit extends at right angles, in plan view, to the moving direction of the slider.

3. The pick-up apparatus for a semiconductor chip according to claim 1, wherein opposite to one of the semiconductor chips, a plurality of the sliders are arranged parallelly in a manner spaced from each other and the plurality of sliders move individually.

4. A pick-up method for a semiconductor chip which delaminates a semiconductor chip mounted on one surface of an adhesive sheet from the one surface of the adhesive sheet by using a pick-up apparatus,
the pick-up apparatus comprising:
a stage on which the adhesive sheet is placed;
at least one or more sliders which come into contact with the other surface of the adhesive sheet and move horizontally, in plan view, with respect to the semiconductor chip;
a slider housing portion which is formed in the stage and houses the slider;
a suction mechanism which is coupled to the stage and suctions the slider housing portion; and
at least one or more slits which are provided on a side where the slider comes into contact with the adhesive sheet, and are in communication with the slider housing portion,
the pick-up method comprising:
placing the adhesive sheet on the stage from a back surface in a position where the slider housing portion is opposed to the semiconductor chip, and bringing the adhesive sheet into contact with the slider;
suctioning the slider housing portion; and
moving the slider horizontally, in plan view, with respect to the semiconductor chip.

5. The pick-up method for a semiconductor chip according to claim 4, wherein in the step of bringing the adhesive sheet into contact with the slider, the adhesive sheet is arranged in a position where a peripheral edge part of the semiconductor chip and a peripheral edge part of the slider housing portion are opposed to each other.
